(19) United States
(12) Patent Application Publication
(10) Pub. No.: US 2026/0197196 A1
(43) Pub. Date: Jul. 9, 2026

(54) MULTICAST IN OVERLAY NETWORK FOR A ROAMING HOST

(71) Applicant: HEWLETT PACKARD ENTERPRISE DEVELOPMENT LP, Spring, TX (US)

(72) Inventors: Tathagata Nandy, Bangalore (IN); V N S Ramaprasad Allu, Bangalore (IN); Thimma Reddy Gadekal, Bangalore (IN); Anoop Govindan Nair, Bangalore (IN)

(21) Appl. No.: 19/090,114

(22) Filed: Mar. 25, 2025

(30) Foreign Application Priority Data
Jan. 7, 2025 (IN) 202541001422

(51) Int. Cl. H04L 12/18; H04L 12/46; H04L 47/70

(52) U.S. Cl. CPC H04L 12/185; H04L 12/4641; H04L 47/70; H04L 2212/00

(57) ABSTRACT

In an overlay network, a network device can receive a first notification message indicating that a host coupled to a second network device of the overlay network has requested to join a multicast group. The network device can generate a mapping between the host and the multicast group based on the first notification message. Upon detecting the host via a port, the network device can generate a second notification message based on the mapping prior to receiving a join request from the host. The network device can send the second notification message to a respective other network device of the overlay network. The network device can receive a set of multicast packets of the multicast group via a tunnel coupled to a source network device in response to the source network device receiving the second notification message and forward the set of multicast packets via the port.

### BACKGROUND

A network device, such as a switch, may support different protocols and services. For example, the network device can support an overlay network formed based on tunneling and virtual private networks (VPNs). The network device can then facilitate overlay routing for a VPN over the tunnels.

### BRIEF DESCRIPTION OF THE FIGURES

FIG. 1A illustrates an example of an overlay network supporting efficient distribution of multicast traffic to a roaming host, in accordance with an aspect of the present application.

FIG. 1B illustrates an example of an overlay network supporting efficient termination of multicast traffic to a network device, in accordance with an aspect of the present application.

FIG. 2 illustrates an example of a notification message indicating a host's request to join a multicast group, in accordance with an aspect of the present application.

FIG. 3A presents a flowchart illustrating an example of a process of a network device in an overlay network efficiently forwarding multicast traffic to a roaming host, in accordance with an aspect of the present application.

FIG. 3B presents a flowchart illustrating an example of a process of a network device in an overlay network generating a mapping for efficiently forwarding multicast traffic to a roaming host, in accordance with an aspect of the present application.

FIG. 4A presents a flowchart illustrating an example of a process of a network device in an overlay network efficiently terminating the forwarding of multicast traffic to a roaming host, in accordance with an aspect of the present application.

FIG. 4B presents a flowchart illustrating an example of a process of a network device in an overlay network determining whether to forward multicast traffic to a roaming host, in accordance with an aspect of the present application.

FIG. 5 presents a flowchart illustrating an example of a process of a network device in an overlay network forwarding multicast traffic received from a tunnel to a roaming host, in accordance with an aspect of the present application.

FIG. 6 illustrates an example of a computing system facilitating efficient distribution of multicast traffic to a roaming host, in accordance with an aspect of the present application.

FIG. 7 illustrates an example of a computer-readable medium (CRM) facilitating efficient distribution of multicast traffic to a roaming host, in accordance with an aspect of the present application.

In the figures, like reference numerals refer to the same figure elements.

### DETAILED DESCRIPTION

Multicast technology plays a crucial role in various Internet applications, allowing efficient content distribution from a single source to multiple hosts through network devices such as switches and routers. This method of data transmission significantly enhances network performance by optimizing bandwidth usage and reducing redundant traffic. To facilitate the distribution of multicast content across a network, network-layer multicast protocols are employed. One commonly used protocol is Protocol-Independent Multicast (PIM), which constructs and maintains multicast distribution trees to ensure efficient delivery of content to all intended recipients. Hosts wishing to receive traffic from a specific multicast group can initiate the process by sending a client join request to an upstream network device. This join request can take the form of an Internet Group Management Protocol (IGMP) request in IPv4 networks or a Multicast Listener Discovery (MLD) request in IPv6 networks. The network device that receives this join request is referred to as the requesting network device.

In a multicast distribution process, the requesting network device can send a network join request (e.g., a PIM join request) to a source network device coupled to the source of the multicast group. Upon receiving this request, the source network device begins forwarding multicast traffic to the requesting network device, establishing a path for content distribution. In more advanced network configurations, the network devices may operate in an overlay network. This overlay network is typically formed using overlay routing techniques for a Virtual Private Network (VPN) across a set of tunnels. One example of an overlay network is the deployment of an Ethernet VPN (EVPN) as an overlay on top of a set of Virtual Extensible Local Area Networks (VXLANs). An overlay network with a VPN can also be referred to as a distributed tunnel fabric. Within this overlay fabric architecture, communication between a pair of network devices within a fabric occurs through a dedicated tunnel between the two. Consequently, each network device within the overlay network functions as a tunnel endpoint. This tunneling mechanism provides a secure and efficient means of transmitting data across the network.

In the context of multicast traffic, both control messages and payload data for the multicast group are forwarded via an established tunnel between the requesting network device and the source network device. This approach ensures that multicast traffic is efficiently distributed across the overlay network while maintaining the benefits of the underlying VPN infrastructure. To efficiently forward multicast traffic in an overlay network, upon receiving a join request (e.g., an IGMP join request) from a host for a multicast group, a requesting network device can send a notification message to a source network device via a corresponding tunnel. The notification message can indicate that the requesting network device has received a request to receive multicast traffic of the multicast group. Accordingly, the source network device can send the multicast traffic to the requesting network device instead of forwarding it to all other network devices in the overlay network. However, if the host roams to a new network device, the multicast traffic is not forwarded to the new network device until the host sends a new join request, thereby causing traffic loss.

The aspects described herein address the problem of loss of multicast traffic forwarded via an overlay network to a roaming host by (i) including an identifier of the host in the notification message indicating the request to receive the multicast traffic of a multicast group; and (ii) upon identifying the identifier at a port, sending another notification message to the source network device without waiting for a join request. When a network device of the overlay network receives the notification message, the network device can maintain a mapping between the identifier and the multicast group. In some examples, the identifier can be a media access control (MAC) address of the host. The host may roam to a new network device and become coupled to a port of the new network device. The new network device can identify the identifier at the port and determine that the host has previously requested the multicast traffic of the multicast group based on the mapping. Accordingly, the new network device can send another notification message without waiting for the join request, thereby readily receiving the multicast traffic from the source network device.

When a user device requests multicast traffic of a multicast group, the user device can be referred to as a requesting host or a host. Furthermore, the network device coupled to the host can be referred to as a requesting network device. If the network is a spine and leaf network, a set of leaf devices can be coupled to another set of spine devices in a tree topology. The spine devices typically facilitate communication among the leaf devices. The leaf devices can be coupled to multicast sources and hosts. The spine devices can then operate as aggregation devices that can aggregate traffic from one or more leaf devices. In addition to operating as an aggregation device, a spine device may couple hosts as well.

In an overlay network, the leaf devices can be the overlay network devices (i.e., tunnel endpoints). The spine devices can be the underlay devices participating in the routing protocol, such as the Border Gateway Protocol (BGP), of the underlay network. The leaf devices can also be in the underlay network and participate in the routing protocol of the underlay network. Because both spine and leaf devices can participate in the routing protocol, the forwarding paths of the tunnels of the overlay network can span both spine and leaf devices in the underlay network. Therefore, the spine devices can be the underlay network devices via which the tunnels are established.

For example, when a leaf device receives a packet from a source destined to a host, the leaf device can encapsulate the packet with a tunnel encapsulation header and forward the encapsulated packet via a corresponding tunnel in the overlay network. The leaf device can forward the encapsulated packet to a spine device via a corresponding path in the underlay network. The spine device can then forward the encapsulated packet toward the destination (i.e., the other endpoint of the tunnel coupled to the host) based on the encapsulation header (e.g., an outer IP address of the encapsulation header). In this way, the encapsulated packet is forwarded via the underlay network between two endpoints of the overlay network.

When a network device (e.g., a leaf device) detects the host from a port (e.g., by detecting an electrical signal at the port), the network device can send a multicast query message to the host. If the host is interested in receiving the multicast traffic of a multicast group, the host can send a join request, such as an IGMP join, for the multicast group. Upon receiving the join request, the requesting network device can then send a notification message to all other network devices of the overlay network. This notification message can indicate that a host coupled to the requesting network device seeks to join the multicast group.

Consequently, the source network device, which is coupled to the source of the multicast group, can determine where to send the multicast traffic received from the source. Accordingly, the source network device can efficiently direct the multicast traffic exclusively to the requesting network device, thereby avoiding unnecessary flooding of the entire overlay network. However, if the host roams to a new network device of the overlay network, the new network device assumes the role of the requesting network device. Despite this transition, the previous requesting network device may continue to receive and subsequently discard the multicast traffic, leading to inefficient use of network bandwidth.

Moreover, until the host sends another join request, the new network device might not send a corresponding notification message indicating that a host coupled to the new network device seeks to join the multicast group. As a result, the source network device may not send the multicast traffic to the new network device until it receives the notification message. This delay can result in a temporary interruption of the flow of multicast traffic to the host and degrade the user experience. In particular, the host may experience a lapse in receiving the multicast traffic, which can hinder the quality of service for an end user. Furthermore, the delay can adversely impact the efficiency and responsiveness of the overlay network in handling roaming (or mobile) hosts and their multicast subscriptions.

To address this issue, when the requesting network device receives a join request from a host, the requesting network device can include an identifier (e.g., a MAC address) of the host in the notification message to indicate which specific host has joined the multicast group. Upon receiving the notification message from the requesting network device, a respective other network device of the overlay network can identify which host coupled to the requesting network device has requested to join the multicast group. Accordingly, the network device can generate a mapping between the identifier and the multicast group and store the mapping in an entry in a data structure of the network device. This data structure can be stored in the memory of the network device.

In some examples, the notification message can be an EVPN type-6 message, which is used to share multicast-related information in the overlay network. This notification message typically does not include individual host information. Therefore, the inclusion of the identifier of the host can enhance the notification message. The identifier can be included in an extended community of the notification message. The extended community can also include an indicator (e.g., a predefined value) that can indicate the presence of the identifier in the notification message. A respective extended community in the notification message can include a particular attribute associated with the information included in the notification message. If the host roams to a new network device, the new network device can detect the host from a local port of the new network device and learn the identifier of the host. For example, the new network device can receive a packet, such as a gratuitous Address Resolution Protocol (ARP) packet, from the host at the port. The new network device can then learn the identifier of the host from the source address of the packet. The new network device can look up the identifier in the data structure and find the matching entry.

Accordingly, the new network device can determine from the mapping in the entry that the host has requested traffic of the multicast group. Hence, the new network device can send a new notification message for the multicast group to all other network devices of the overlay network. In this way, the new network device can become the new requesting device. When the source network device receives the notification message, the source network device can start sending the multicast traffic to the new network device. Upon receiving the multicast traffic, the new network device can forward the multicast traffic via the port coupled to the host. The new network device can also send a group-specific multicast query for the multicast group to the host. If the host is still interested in receiving the multicast traffic, the host can send another join request. Accordingly, the new network device can confirm that the new notification message is sent correctly and allocate the port as the egress port.

If the host is no longer interested in receiving the multicast traffic, the host does not send the join request in response to the multicast query. If the new network device does not receive the join request within a predetermined period (e.g., a timeout period), the new network device can determine whether it is coupled to any other host that has sent a join request for the multicast group. If no such host is detected, the new network device can send a withdrawal notification message indicating that the new network device is not coupled to any host requesting multicast traffic of the multicast group. When the source network device receives the withdrawal notification message, the source network device can stop sending the multicast traffic to the new network device.

Furthermore, upon learning the identifier of the host, the new requesting network device can also send a control message (e.g., an EVPN type-2 message) comprising the identifier to all other network devices of the overlay network. For example, if the identifier is a MAC address, the new requesting network device can learn the MAC address from the gratuitous ARP packet received from the host (e.g., based on Ethernet MAC address learning). When the previous requesting network device receives the control message via a corresponding tunnel, the previous requesting network device can learn the identifier from the tunnel and determine that the host has roamed away. Accordingly, the previous requesting network device can send a withdrawal notification message to the source network device to stop sending the multicast traffic.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to an endpoint of a link that can receive or transmit data. “Port” can also refer to the hardware, software, and/or firmware logic that can facilitate the operations of that port.

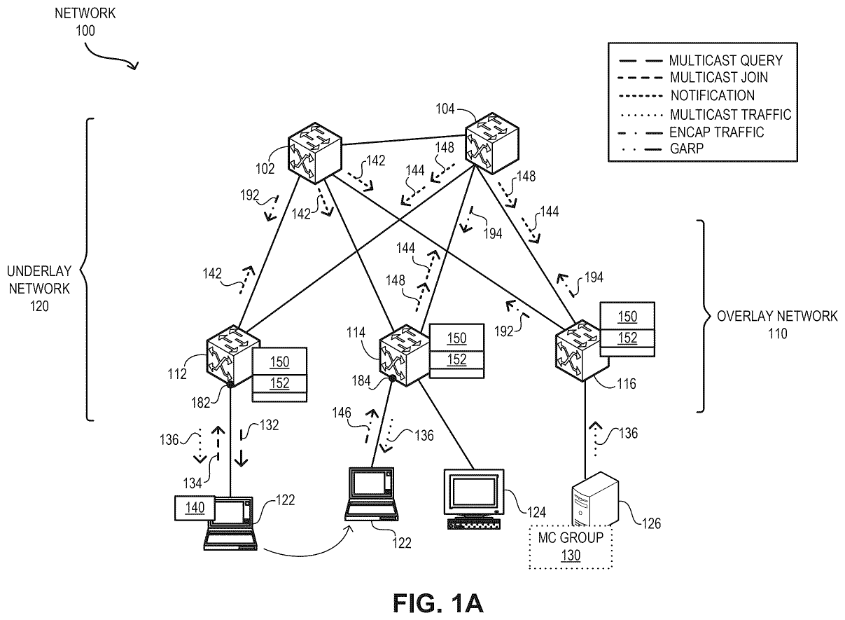

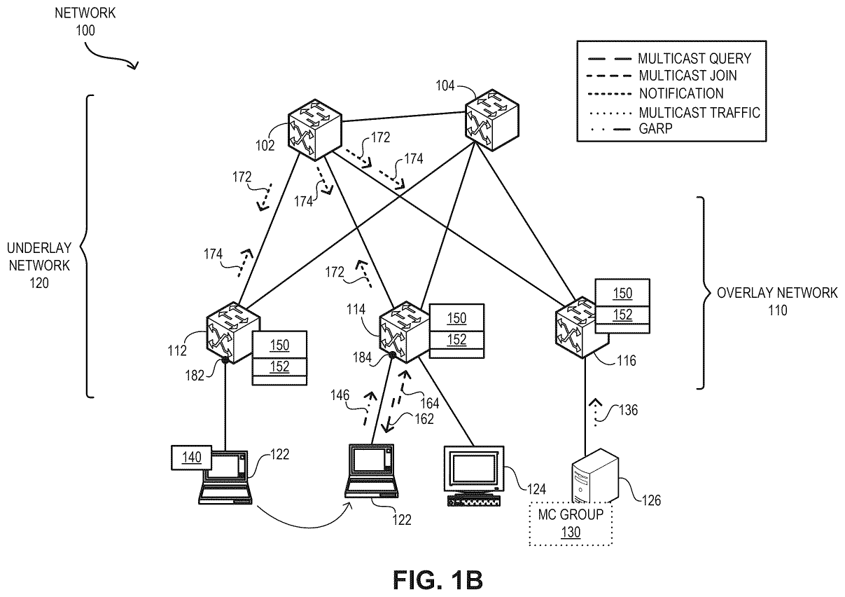

FIG. 1A illustrates an example of an overlay network supporting efficient distribution of multicast traffic to a roaming host, in accordance with an aspect of the present application. A network 100 can include a number of network devices (e.g., switches), and may include heterogeneous network components, such as layer-2 and layer-3 hops, and tunnels. In some examples, network 100 can be an Ethernet network, InfiniBand network, or other network, and may use a corresponding communication protocol, such as IP, FibreChannel over Ethernet (FCoE), or other protocol. Network 100 can include a number of network devices 102, 104, 112, 114, and 116. User devices 122, 124, and 126 can be coupled to network devices 112, 114, and 116, respectively. In this example, user device 126 can be a source for multicast group 130 and hence, can also be referred to as source 126. Furthermore, user device 122 can request multicast traffic of multicast group 130 and, hence, can also be referred to as host 122.

A respective network device in network 100 can be assigned a MAC address and an IP address and can include at least one processing resource. Examples of a processing resource can include, but are not limited to, a processor core, a graphics processing unit (GPU), and a tensor processing unit (TPU). The network device can also include at least one non-transitory computer-readable medium storing instructions that, when executed by the processing resource, causes the processing resource to perform one or more operations. The network device can further include forwarding hardware (e.g., the application-specific integrated circuit (ASIC) of the network device, which can at least incorporate a Ternary content-addressable memory (TCAM)).

Network devices 112, 114, and 116 can be in an overlay network 110, which can be a distributed tunnel fabric, where the network devices can be coupled to each other via tunnels. In overlay network 110, tunnel encapsulation is initiated and terminated within overlay network 110. Network devices in overlay network 110 may form a mesh of tunnels. Examples of a tunnel can include, but are not limited to, VXLAN, Generic Routing Encapsulation (GRE), Network Virtualization using GRE (NVGRE), Generic Networking Virtualization Encapsulation (Geneve), Internet Protocol Security (IPsec), and Multiprotocol Label Switching (MPLS). A VPN, such as an EVPN, can be deployed over overlay network 110. The tunnels in overlay network 110 can be formed over an underlay network 120. Underlay network 120 can be a physical network, and a respective link of underlay network 120 can be a physical link.

A respective network device in overlay network 110 can also be in underlay network 120. Here, a network device operating as a tunnel endpoint can also be in underlay network 120. A respective pair of network devices in underlay network 120 can be a BGP peer. Therefore, in underlay network 120, a respective network device can use BGP to establish routes via which packets are forwarded. Accordingly, the encapsulated packets of overlay network 110 can be forwarded via these routes in underlay network 120. In some examples, network 100 can be a spine and leaf network wherein network devices 112, 114, and 116 can be leaf devices, and network devices 102 and 104 can be spine devices. Here, leaf devices 112, 114, and 116 can be in overlay network 110 as tunnel endpoints. On the other hand, spine devices 102 and 104 can be in underlay network 120 via which the tunnels of overlay network 110 are established. Under such a spine-and-leaf network topology, spine devices 102 and 104 can operate as aggregation devices that can aggregate traffic from leaf devices 112, 114, and 116.

During operation, network device 112, which can be a leaf device, can detect host 122 from port 182 of network device 112. Network device 112 can then send a multicast query message 132 to host 122. Network device 112 can send query message 132 to determine the multicast reception state associated with port 182. Accordingly, query message 132 can query host 122 to determine whether host 122 is interested in receiving multicast traffic of any multicast group. If host 122 is interested in receiving the multicast traffic of multicast group 130, host 122 can respond to query message 132 by sending join request 134 for multicast group 130 to network device 122. Query message 132 and join request 134 can be IGMP messages. Upon receiving join request 134, network device 112 can send a notification message 142 to all network devices 114 and 116 via corresponding tunnels. Notification message 142 can be an EVPN type-6 message and can indicate that a host coupled to network device 112 has requested multicast traffic of multicast group 130 (e.g., seeks to join multicast group 130). Notification message 142 can specify a multicast address (e.g., a multicast Internet Protocol (IP) address) of multicast group 130.

When source 126 starts transmitting multicast traffic 136 of multicast group 130, network device 116 can receive multicast traffic 136 since it is coupled to source 126. Multicast traffic 136 can include a set of multicast packets of multicast group 130. The set of multicast packets can be destined to a multicast group address representing multicast group 130. Upon receiving notification message 142, network device 116 can determine where to send multicast traffic 136 received from source 126. Accordingly, network device 116 can encapsulate multicast traffic 136 with an encapsulation header with network device 112's IP address as the destination address to generate encapsulated multicast traffic 192.

Subsequently, network device 116 can forward encapsulated multicast traffic 192 to network device 112 over the tunnel between network devices 112 and 116. When network device 112 receives encapsulated multicast traffic 192, network device 112 can decapsulate the encapsulation header and obtain multicast traffic 136. Network device 112 can then forward multicast traffic 136 (i.e., the set of multicast packets) to host 122 via port 182. In this way, network device 116 can avoid unnecessary flooding of multicast traffic 136 in overlay network 110.

However, if host 122 roams to network device 114 (denoted with an arrow), network device 114 assumes the role of the requesting network device for host 122. Despite this transition, network device 112 may continue to receive and subsequently discard encapsulated multicast traffic 192, leading to inefficient use of network bandwidth. Moreover, until host 122 sends another join request, network device 114 might not send a corresponding notification message indicating that a coupled to network device 114 seeks to join multicast group 130. As a result, network device 116 may not send multicast traffic 136 to network device 114 until network device 116 receives the notification message. This delay can result in a temporary interruption of the flow of multicast traffic to host 122 and degrade the user experience. Furthermore, the delay can adversely impact the efficiency and responsiveness of overlay network 110 in handling roaming (or mobile) hosts and their multicast subscriptions.

To address this issue, when network device 112 receives join request 134 from host 122, network device 112 can include an identifier 140 (e.g., a MAC address) of host 122 in notification message 142. Hence, notification message 142 can indicate which specific host (i.e., host 122) coupled to network device 112 has requested traffic of multicast group 130. In some examples, notification message 142 can be an EVPN type-6 message, which is used to share multicast-related information in overlay network 110. Since notification message 142 typically does not include individual host information, the inclusion of identifier 140 can enhance notification message 142. Identifier 140 can be included in an extended community of notification message 142. The extended community can also include an indicator (e.g., a predefined value) that can indicate the presence of identifier 140 in notification message 142. A respective extended community in notification message 142 can include a particular attribute associated with the information included in notification message 142.

Upon receiving notification message 142 from network device 112, network devices 114 and 116 can determine, based on identifier 140, that host 122 is coupled to network device 112 and has requested to join multicast group 130. Network devices 114 and 116 can generate a mapping 152 between identifier 140 of host 122 and multicast group 130. Mapping 152 can be stored in an entry in data structure 150, which can be stored in respective memories of network devices 114 and 116. In some examples, when network device 112 receives join request 134, network device 112 can also generate mapping 152 between identifier 140 and multicast group 130, and store mapping 152 can be stored in an entry in data structure 150.

If host 122 roams to network device 114, host 122 can become coupled to port 184 of network device 114. Subsequently, network device 114 can detect host 122 from port 184 and learn identifier 140 of host 122. For example, when host 122 roams to network device 114, host 122 can send a gratuitous ARP packet 146. Network device 114 can receive packet 146 at port 184 and can learn identifier 140 of host 122 from the source address of packet 146 (e.g., based on Ethernet MAC address learning). Network device 114 can look up identifier 140 in data structure 150 and find the matching entry comprising mapping 152. Network device 114 can determine from mapping 152 that host 122 has requested traffic of multicast group 130. Network device 114 can then send, without waiting for a join request from host 122, a new notification message 144 for multicast group 130 to network devices 112 and 116. In other words, network device 114 can send notification message 144 prior to receiving a join request from host 122.

When network devices 112 and 116 receive notification message 144, network devices 112 and 116 may refresh the entry comprising mapping 152. Furthermore, upon receiving notification message 144, network device 116 can determine that network device 114 is coupled to a host that has requested multicast traffic of multicast group 130. Accordingly, network device 116 can encapsulate multicast traffic 136 with an encapsulation header with network device 114's IP address as the destination address to generate encapsulated multicast traffic 194. Here, multicast traffic 136 can include a subsequent set of multicast packets, which are transmitted after the set of multicast packets sent via network device 112. Network device 116 can forward encapsulated multicast traffic 194 to network device 114 over the tunnel between network devices 114 and 116. When network device 114 receives encapsulated multicast traffic 194, network device 114 can decapsulate the encapsulation header and obtain multicast traffic 136. Network device 114 can then determine port 184 as the egress port for multicast traffic 136 and forward multicast traffic 136 to host 122 via port 184. In this way, network device 114 can efficiently direct multicast traffic 136 to roaming host 122.

FIG. 1B illustrates an example of an overlay network supporting efficient termination of multicast traffic to a network device, in accordance with an aspect of the present application. To verify whether host 122 is still interested in receiving multicast traffic 136, network device 114 can send a group-specific multicast query message 162 for multicast group 130 to host 122 via port 184. If host 122 is still interested in receiving multicast traffic 136, host 122 can send another join request 164 for multicast group 130 as a response to query message 162. When network device 114 receives join request 164, network device 114 can confirm that notification message 144 has been sent correctly and allocate port 184 as the egress port.

On the other hand, if host 122 is no longer interested in receiving multicast traffic 136, host 122 does not send a join request in response to query message 162. If network device 114 does not receive a join request within a predetermined period (e.g., a timeout period), network device 114 can determine whether it is coupled to any other host that has sent a join request for multicast group 130. If no such host is detected, network device 114 can send a withdrawal notification message 148 indicating that network device 114 is not coupled to any host requesting multicast traffic 136 of multicast group 130. When network device 116 receives notification message 148, network device 116 can stop sending multicast traffic 136 to network device 114.

When host 122 roams to network device 114 and becomes coupled to port 184, network device 114 can learn identifier 140 of host 122 from port 184. For example, if identifier 140 is a MAC address, network device 114 can learn the MAC address from gratuitous ARP packet 146 received from host 122 based on Ethernet MAC address learning. Typically, when a network device in overlay network 110 learns an identifier, such as a MAC address, the network can share the identifier with other network devices of overlay network using an EVPN type-2 message. Accordingly, network device 114 can then send a control message 172 (e.g., an EVPN type-2 message) comprising identifier 140 to network devices 112 and 116.

When network device 112 receives control message 172 over a tunnel between network devices 112 and 114, network device 112 can obtain identifier 140 from control message 172 and, hence, learn identifier 140 from the tunnel. Before host 122 roams to network device 114, network device 112 has previously learned identifier from port 182, as described in conjunction with FIG. 1A. Since network device 112 relearns identifier 140 from the tunnel coupled to network device 114, network device 112 can determine that host 122 has roamed away from port 182 to network device 114. Network device 112 can then determine whether it is coupled to any other host that has sent a join request for multicast group 130. If no such host is detected, network device 112 can send a withdrawal notification message 174 indicating that network device 112 is not coupled to any host requesting multicast traffic 136 of multicast group 130. When network device 116 receives notification message 174, network device 116 can stop sending multicast traffic 136 to network device 112.

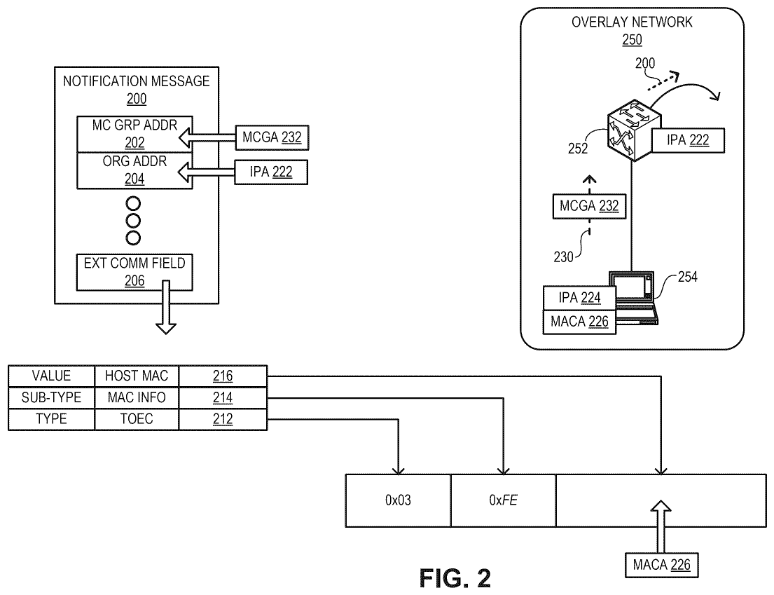

FIG. 2 illustrates an example of a notification message indicating a host's request to join a multicast group, in accordance with an aspect of the present application. A notification message 200 can be used to notify whether a host coupled to a network device has requested multicast traffic of a multicast group. For example, in overlay network 250, network device 252 can send notification message 200 upon receiving a join request 230 (e.g., an IGMP join) from host 254, which can be coupled to network device 252. Here, network device 252 can be allocated with IP address 222. Similarly, host 254 can be allocated with IP address 224 and MAC address 226. Upon receiving join request 230, network device 252 can send notification message 200 to a respective other network device (not shown in FIG. 2) via corresponding tunnels.

Notification message 200 can be an EVPN type-6 message, as defined in Internet Engineering Task Force (IETF) Request for Comments (RFC) 9251. Notification message 200 can include a number of fields, such as multicast group address 202 and an originator address 204. It should be noted that notification message 200 may include more fields not shown in FIG. 2. Multicast group address 202 can be the address of the multicast group in which host 254 is intended to join, as indicated in join request 230. If join request 230 includes multicast group address 232, multicast group address 202 of notification message 200 can include multicast group address 232. The multicast traffic of the multicast group can include a set of multicast packets of the multicast group destined to multicast group address 232.

Originator address 204 can be the IP address of the network device originating notification message 200. Therefore, originator address 204 of notification message 200 can include IP address 222 of network device 252. Consequently, when another network device of overlay network 250 receives notification message 200, it can determine that a network device associated with IP address 222 (i.e., network device 252) is coupled to a host (i.e., host 254) that has requested to receive multicast traffic associated with multicast group address 232.

Notification message 200 can be further enhanced by including MAC address 226 of host 254. MAC address 226 can be included in an extended community field 208 of notification message 200. In some examples, IP address 224 may also be included in field 208. Field 208 can represent a BGP Extended Community, as defined in IETF RFC 4360. For example, extended community field 208 can indicate a Transitive Opaque Extended Community (TOEC), as indicated in IETF RFC 7153. As a result, if a network device does not support the inclusion of a MAC address in notification message 200, the network device can process the rest of the fields of notification message 200.

Field 208 can include a set of sub-fields representing MAC address 226. The set of sub-fields can include a type 212, a sub-type 214, and a value 216. Type 212 can indicate the generic type of field 208 (e.g., a TOEC field) that can be defined in accordance with the standard (e.g., the BGP Extended Communities Attribute). Sub-type 214 can be a specialized value indicating that field 208 corresponds to the MAC address information of a host. Hence, sub-type 214 can be the indicator that can indicate the presence of the MAC address in notification message 200. Value 216 can then include the MAC address of the host.

In this example, type 212 can include a value of “0x03,” which can indicate that field 208 is a TOEC field. Sub-type 214 can include a predetermined specialized value, which can be the indicator indicating the presence of MAC address 226 in notification message 200. In some examples, the specialized value can be “0xFE.” Any network device that supports the inclusion of a MAC address in notification message 200 (i.e., can support sub-type 214) can recognize this specialized value and determine that field 208 corresponds to a MAC address of a host. Accordingly, value 216 can include MAC address 226 of host 254.

When another network device of overlay network 250 receives notification message 200, that network device can recognize the specialized value of sub-type 214 and obtain MAC address 226 from value 216. The other network device can generate a mapping between MAC address 226 and multicast group address 232. The mapping can be stored in an entry in a data structure stored in the memory of the network device. In this way, notification message 200 can efficiently notify the other network device that the device associated with MAC address 226 has requested traffic associated with multicast group address 232.

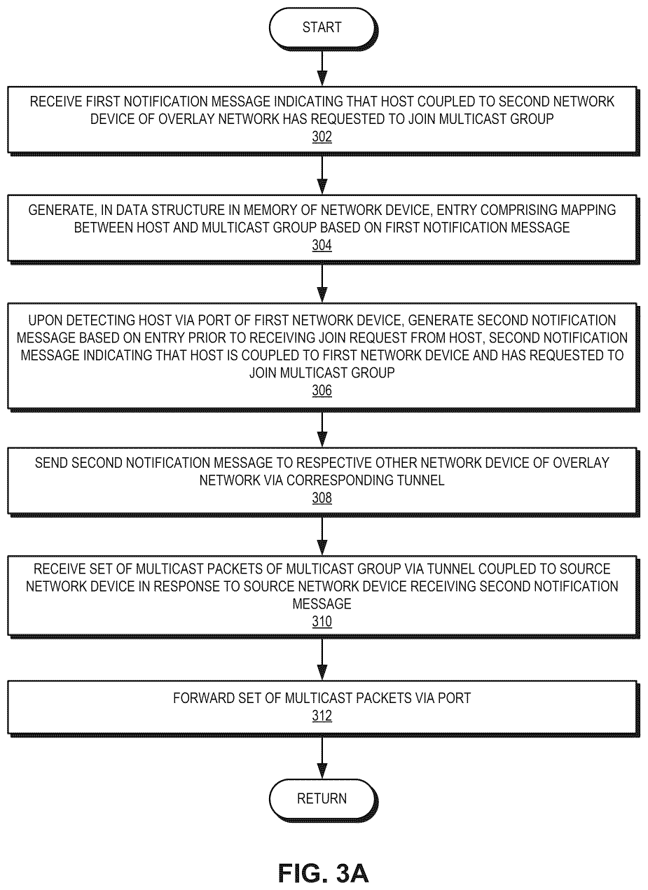

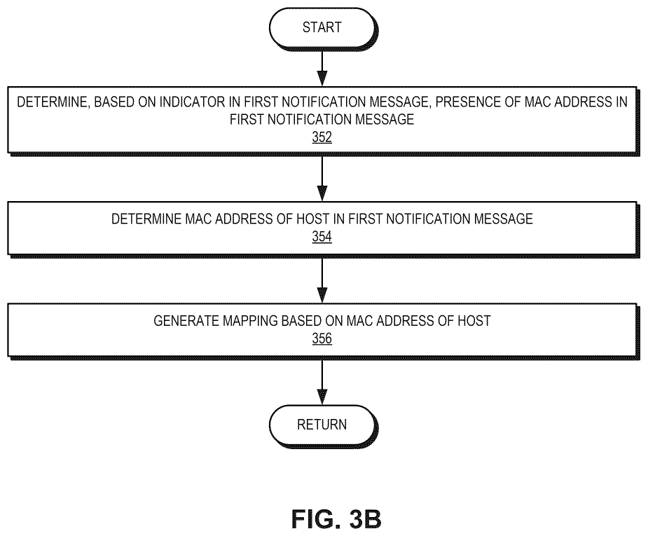

FIG. 3A presents a flowchart illustrating an example of a process of a network device in an overlay network efficiently forwarding multicast traffic to a roaming host, in accordance with an aspect of the present application. During operation, the network device can receive a first notification message indicating that a host coupled to the second network device of the overlay network has requested to join a multicast group (operation 302). If the host is interested in receiving the multicast traffic of the multicast group, the host can send a join request, such as an IGMP join, for the multicast group. Upon receiving the join request, the second network device can send the first notification message to all other network devices of the overlay network. As a result, the network device can receive the first notification message. In the example in FIG. 1A, upon receiving join request 134 from host 122, network device 112 can send notification message 142, which can be received by network device 114 over a corresponding tunnel.

The network device can then generate, in a data structure in the memory of the network device, an entry comprising a mapping between the host and the multicast group based on the first notification message (operation 304). Upon receiving the first notification message, the network device can identify which host coupled to the second network device has requested to join the multicast group. Accordingly, the network device can generate the mapping between the host and the multicast group and store the mapping in the entry in the data structure. In the example in FIG. 1A, network device 114 can generate mapping 152 between identifier 140 of host 122 and multicast group 130 in an entry in data structure 150.

The network device, upon detecting the host via a port of the network device, can generate a second notification message based on the entry prior to receiving a join request from the host (operation 306). Here, the second notification message can indicate that the host is coupled to the first network device and has requested to join the multicast group. The second notification message can be an EVPN type-6 message comprising the respective IP addresses of the network device and the multicast group. In the example in FIG. 1A, upon detecting host 122 via port 184, network device 114 can generate notification message 144 based on entry 152 prior to receiving a join request from host 122.

The network device can then send the second notification message to a respective other network device of the overlay network via a corresponding tunnel (operation 308). Because the second notification message indicates the multicast group and the host, a source network device can determine that the host has requested multicast traffic of the multicast group. In the example in FIG. 1A, network device 114 can send notification message 144 to network devices 112 and 116 via corresponding tunnels. When network device 116, which is the source network device, receives notification message 144, network device 116 can determine that host 122 has requested multicast traffic of multicast group 130.

The network device can then receive a set of multicast packets of the multicast group via a tunnel coupled to the source network device in response to the source network device receiving the second notification message (operation 310). When the source network device receives the second notification message, the source network device can start forwarding the set of multicast packets of the multicast group to the network device, which can receive the set of multicast packets via the tunnel. In the example in FIG. 1A, network device 114 can receive multicast traffic 136 from network device 116. The network device can then forward the set of multicast packets via the port (operation 312). Since the set of multicast packets is received via the tunnel, the network device can decapsulate the encapsulation headers associated with the tunnel and forward the set of multicast packets to the host. In the example in FIG. 1A, network device 114 can forward multicast traffic 136 via port 184.

FIG. 3B presents a flowchart illustrating an example of a process of a network device in an overlay network generating a mapping for efficiently forwarding multicast traffic to a roaming host, in accordance with an aspect of the present application. During operation, the network device can determine, based on an indicator in the first notification message, the presence of the MAC address in the first notification message (operation 352). Here, the network device and the first notification message can correspond to the network device and the first notification message, respectively, of FIG. 3A. The first notification message can be an EVPN type-6 message comprising an extended community field. The extended community field can include a predetermined value indicating the presence of an identifier of a host in the notification message. In the example in FIG. 2, notification message 200 can include an extended community field 208, which can include a sub-type 214 indicating that field 208 corresponds to the MAC address information of a host. Hence, sub-type 214 can be the indicator that can indicate the presence of the MAC address in notification message 200.

The network device can determine the MAC address of a host in the first notification message (operation 354). When the network device receives the first notification message, the network device can detect the indicator and determine that the first notification message includes an identifier, such as the MAC address, of a host. In the example in FIG. 2, network device 252 can determine the presence of an identifier in notification message 200 based on the predetermined value in sub-type 214. Network device 252 can then determine MAC address 226 of host 254 in notification message 200. The network device can then generate the mapping based on the MAC address of the host (operation 356). When the network device obtains the MAC address and the multicast group address from the notification message, the network device can generate the mapping between the MAC address and the multicast group address. The mapping can be stored in an entry in a data structure stored in the memory of the network device. In the example in FIG. 2, when another network device of overlay network 250 receives notification message 200 from network device 252, it can generate a mapping between MAC address 226 and multicast group address 232.

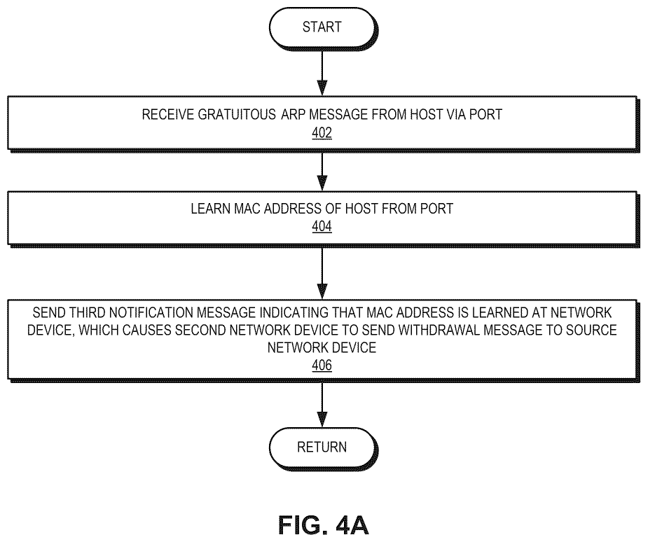

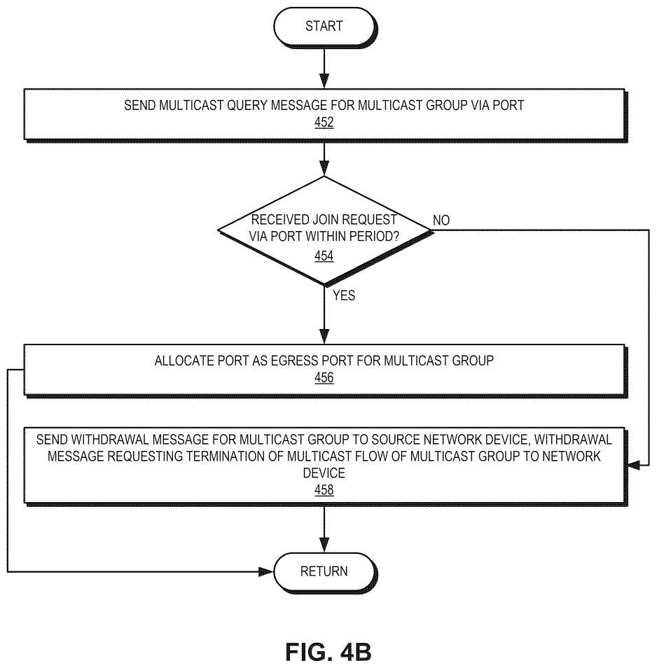

FIG. 4A presents a flowchart illustrating an example of a process of a network device in an overlay network efficiently terminating the forwarding of multicast traffic to a roaming host, in accordance with an aspect of the present application. During operation, the network device can receive a gratuitous ARP message from the host via the port (operation 402). Here, the network device and the host can correspond to the network device and the host, respectively, of FIG. 3A. When the host is coupled to the network device via the port, the host can send the gratuitous ARP message to notify the host about its MAC address. The network device can then learn the MAC address from the gratuitous ARP message (operation 404). For example, the network device can learn the MAC address based on Ethernet MAC address learning. In the example in FIG. 1A, when host 122 sends gratuitous ARP 146, network device 114 can receive it via port 184. Subsequently, network device 114 can learn the MAC address of host 122 from port 184.

The network device can then send a third notification message indicating that the MAC address is learned at the network device (operation 406). A second network device can receive the third notification message and learn the MAC address from a tunnel between the network device and the second network device. Here, the second network device can correspond to the second network device of FIG. 3A. Accordingly, the second network device can determine that the host has roamed away. Therefore, the second network device can send a withdrawal message to a source network device. In the example in FIG. 1B, network device 112 can receive notification message 172 from network device 114. Accordingly, network device 114 can send a withdrawal notification message 174 to network device 116.

FIG. 4B presents a flowchart illustrating an example of a process of a network device in an overlay network determining whether to forward multicast traffic to a roaming host, in accordance with an aspect of the present application. During operation, the network device can send a multicast query message for the multicast group via the port (operation 452). Here, the network device and multicast group can correspond to the network device and multicast group, respectively, of FIG. 3A. To verify whether the host is still interested in receiving the multicast traffic of the multicast group, the network device can send a multicast query message to the host via the port. In the example in FIG. 1B, network device 114 can send a multicast query message 162 for multicast group 130 to host 122 via port 184 to determine whether host 122 is still interested in receiving multicast traffic 136.

The network device can then determine whether it has received a join request via the port within a predetermined period (e.g., a timeout period) (operation 454). If the host is still interested in receiving the multicast traffic of the multicast group, the host can send a join request for the multicast group as a response to the query message within the predetermined period. Under such circumstances, the network device can receive a join request from the host via the port. Subsequently, the network device can allocate the port as the egress port for the multicast group (operation 456). In the example in FIG. 1B, if host 122 is still interested in receiving multicast traffic 136, host 122 can send join request 164 for multicast group 130 as a response to query message 162. When network device 114 receives join request 164, network device 114 can allocate port 184 as the egress port.

On the other hand, if the host is no longer interested in receiving the multicast traffic, the host does not send a join request in response to the query message. If the network device does not receive a join request within the predetermined period, the network device can send a withdrawal message to the source network device (operation 458). The withdrawal message can request the termination of the multicast flow of the multicast group to the network device. Here, the multicast flow includes the forwarding of multicast traffic from the source network device to the network device. In the example in FIG. 1B, network device 114 can send a withdrawal notification message 148 indicating that network device 114 is not coupled to any host requesting multicast traffic 136 of multicast group 130. When network device 116 receives notification message 148, network device 116 can stop sending multicast traffic 136 to network device 114.

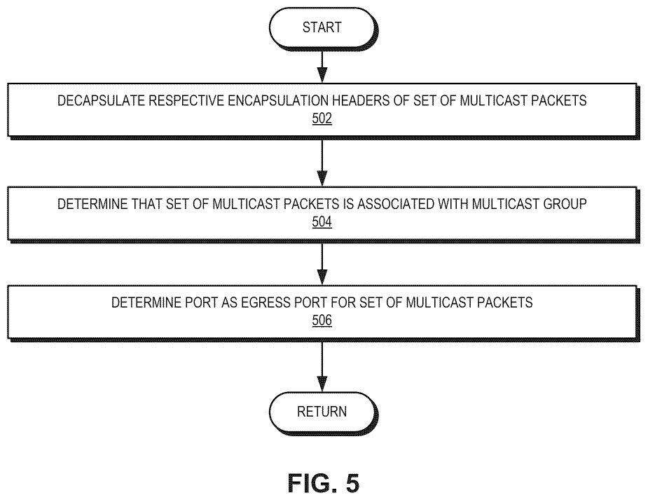

FIG. 5 presents a flowchart illustrating an example of a process of a network device in an overlay network forwarding multicast traffic received from a tunnel to a roaming host, in accordance with an aspect of the present application. During operation, the network device can decapsulate respective encapsulation headers of the set of multicast packets (operation 502). Here, the network device and the set of multicast packets can correspond to the network device and the set of multicast packets, respectively, of FIG. 3A. Since the set of multicast packets is sent over a tunnel between the network device and the source network device, these packets are encapsulated with respective encapsulation headers associated with the tunnel. Therefore, to obtain the packets, the network device can decapsulate the corresponding encapsulation headers. In the example in FIG. 1A, network device 114 can receive encapsulated multicast traffic 194 over the tunnel between network devices 114 and 116. Network device 114 can then decapsulate the encapsulation headers to obtain multicast traffic 136.

The network device can then determine that the set of multicast packets is associated with the multicast group (operation 504). The set of multicast packets can be destined to a multicast group address of the multicast group. Based on the multicast group address, the network device can determine that the set of multicast packets is associated with the multicast group. The network device can then determine the port as the egress port for the set of multicast packets (operation 508). Since the port is coupled to the host, the port can be allocated as the egress port for the multicast group. Hence, the network device can determine the port as the egress port for the multicast packets of the multicast group. In the example in FIG. 1A, network device 114 can determine port 184 as the egress port for multicast traffic 136.

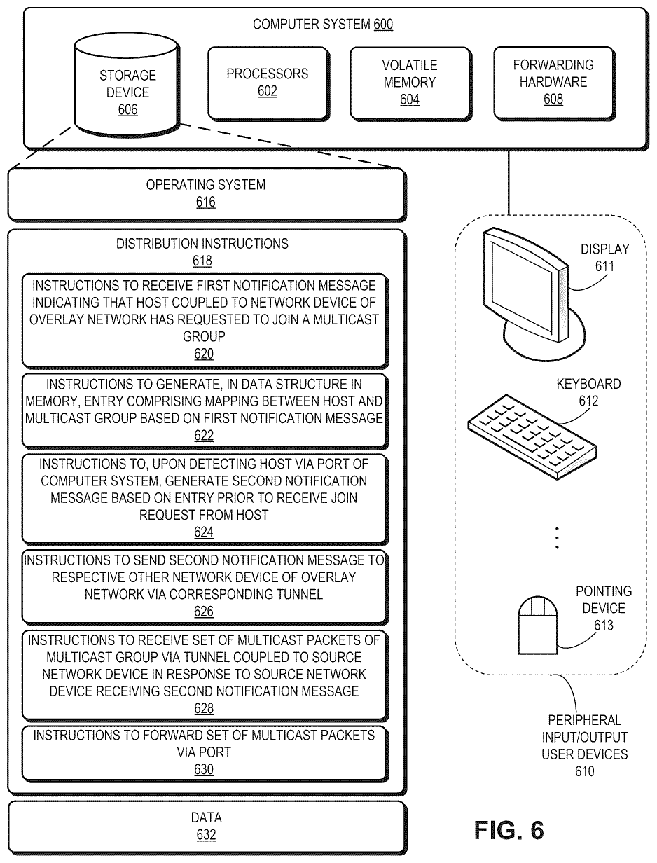

FIG. 6 illustrates an example of a computing system facilitating efficient distribution of multicast traffic to a roaming host, in accordance with an aspect of the present application. Computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Forwarding hardware 608 can include a TCAM. Storage device 606 includes a non-transitory computer-readable storage medium and stores an operating system 616, distribution instructions 618, and data 632. Computer system 600 may include fewer or more entities or instructions than those shown in FIG. 6.

Distribution instructions 618 can include instructions, which when executed by computer system 600, can cause computer system 600 to perform methods and/or processes described in this disclosure. Distribution instructions 618 can be executed on at least one of processors 602, forwarding hardware 608, or a combination thereof. Computer system 600 can be a network device in an overlay network, such as network device 114 in FIGS. 1A and 1B and network device 252 in FIG. 2. Specifically, distribution instructions 618 may include instructions 620 to receive a first notification message indicating that a host coupled to a network device of the overlay network has requested to join a multicast group. Upon receiving a join request for the multicast group, the network device can send the first notification message to all other network devices of the overlay network. As a result, computer system 600 can receive the first notification message. In the example in FIG. 1A, upon receiving join request 134 from host 122, network device 112 can send notification message 142, which can be received by network device 114 over a corresponding tunnel.

Distribution instructions 618 may also include instructions 622 to generate, in a data structure in memory 604, an entry comprising a mapping between the host and the multicast group based on the first notification message. In the example in FIG. 1A, network device 114 can generate mapping 152 between identifier 140 of host 122 and multicast group 130 in an entry in data structure 150. Furthermore, distribution instructions 618 may also include instructions 624 to, upon detecting the host via a port of computer system 600, generate a second notification message based on the entry prior to receiving a join request from the host. The first and second notification messages can be EVPN type-6 messages. In the example in FIG. 1A, upon detecting host 122 via port 184, network device 114 can generate notification message 144 based on entry 152 prior to receiving a join request from host 122.

Distribution instructions 618 may include instructions 626 to send the second notification message to a respective other network device of the overlay network via a corresponding tunnel. In the example in FIG. 1A, network device 114 can send notification message 144 to network devices 112 and 116 via corresponding tunnels. When network device 116, which is the source network device, receives notification message 144, network device 116 can determine that host 122 has requested multicast traffic of multicast group 130. Distribution instructions 618 may include instructions 628 to receive a set of multicast packets of the multicast group via a tunnel coupled to the source network device in response to the source network device receiving the second notification message. In the example in FIG. 1A, network device 114 can receive multicast traffic 136 from network device 116.

Moreover, distribution instructions 618 may include instructions 630 to forward the set of multicast packets via the port. In the example in FIG. 1A, network device 114 can forward multicast traffic 136 via port 184. Data 632 can include any data that is required as input, or that is generated as output by the methods, operations, communications, and/or processes described in this disclosure. Specifically, data 632 can include mappings between respective identifiers of hosts and corresponding multicast groups (e.g., mapping 152 in FIG. 1A) and a respective identifier, such as a MAC address, learned by a network device. Data 632 can also include the predefined value of the indicator indicating the presence of an identifier of a host in a notification message (e.g., the predefined value of sub-type 214 in field 208 of notification message 200 of FIG. 2).

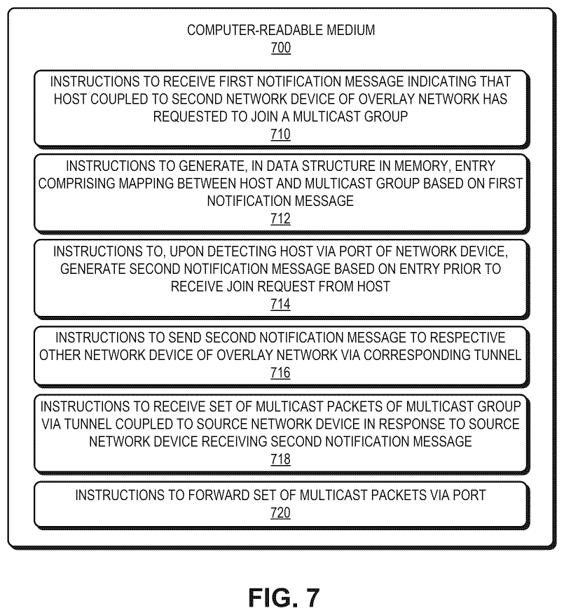

Computer system 600 and distribution instructions 618 may include more instructions than those shown in FIG. 6. For example, distribution instructions 618 can also store instructions for learning identifier 140 of host 122 by network device 114 from gratuitous ARP 146 of FIG. 1A; sending a multicast query message 162 to determine whether host 122 is still interested in receiving multicast traffic 136 of FIG. 1B; determining, based on join request 164, that host 122 is still interested in receiving multicast traffic 136 of FIG. 1B; sending a withdrawal notification message 174 in response to detecting that host 122 has roamed away from network device 114 of FIG. 1B; determining, based on an indicator (i.e., sub-type 214), the presence of MAC address 232 of host 254 in notification message 200 of FIG. 2; the operations depicted in the flowcharts of FIGS. 3, 4, and 5; and the instructions of non-transitory CRM 700 in FIG. 7.

FIG. 7 illustrates an example of a CRM facilitating efficient distribution of multicast traffic to a roaming host, in accordance with an aspect of the present application. CRM 700 can include one or more non-transitory computer-readable mediums or devices storing instructions that, when executed by a computer or processor, cause the computer or processor to perform a method. Therefore, the instructions in CRM 700 can be stored in one or more non-transitory computer-readable mediums or devices. CRM 700 can store instructions 710 to receive, by a network device of an overlay network, a first notification message indicating that a host coupled to a second network device of the overlay network has requested to join a multicast group. In the example in FIG. 1A, upon receiving join request 134 from host 122, network device 112 can send notification message 142, which can be received by network device 114 over a corresponding tunnel.

CRM 700 can also include instructions 712 to generate, in a data structure in the memory of the network device, an entry comprising a mapping between the host and the multicast group based on the first notification message. In the example in FIG. 1A, network device 114 can generate mapping 152 between identifier 140 of host 122 and multicast group 130 in an entry in data structure 150. CRM 700 can include instructions 714 to, upon detecting the host via a port of the network device, generate a second notification message based on the entry prior to receiving a join request from the host. In the example in FIG. 1A, upon detecting host 122 via port 184, network device 114 can generate notification message 144 based on entry 152 prior to receiving a join request from host 122.

CRM 700 can also include instructions 716 to send the second notification message to a respective other network device of the overlay network via a corresponding tunnel. In the example in FIG. 1A, network device 114 can send notification message 144 to network devices 112 and 116 via corresponding tunnels. When network device 116, which is the source network device, receives notification message 144, network device 116 can determine that host 122 has requested multicast traffic of multicast group 130.

Moreover, CRM 700 can include instructions 718 to receive a set of multicast packets of the multicast group via a tunnel coupled to the source network device in response to the source network device receiving the second notification message. In the example in FIG. 1A, network device 114 can receive multicast traffic 136 from network device 116. Furthermore, CRM 700 can include instructions 720 to forward the set of multicast packets via the port. In the example in FIG. 1A, network device 114 can forward multicast traffic 136 via port 184.

CRM 700 may include more instructions than those shown in FIG. 7. For example, CRM 700 can also store instructions for learning identifier 140 of host 122 by network device 114 from gratuitous ARP 146 of FIG. 1A; sending a multicast query message 162 to determine whether host 122 is still interested in receiving multicast traffic 136 of FIG. 1B; determining, based on join request 164, that host 122 is still interested in receiving multicast traffic 136 of FIG. 1B; sending a withdrawal notification message 174 in response to detecting that host 122 has roamed away from network device 114 of FIG. 1B; determining, based on an indicator (i.e., sub-type 214), the presence of MAC address 232 of host 254 in notification message 200 of FIG. 2; the operations depicted in the flowcharts of FIGS. 3, 4, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a network device in an overlay network. During operation, the network device can receive a first notification message indicating that a host coupled to a second network device of the overlay network has requested to join a multicast group. The network device can generate, in a data structure in the memory of the network device, an entry comprising a mapping between the host and the multicast group based on the first notification message. Upon detecting the host via a port of the network device, the network device can generate a second notification message based on the entry prior to receiving a join request from the host. Here, the second notification message indicates that the host is coupled to the network device and has requested to join the multicast group. The network device can then send the second notification message to a respective other network device of the overlay network via a corresponding tunnel. Subsequently, the network device can receive a set of multicast packets of the multicast group via a tunnel coupled to a source network device in response to the source network device receiving the second notification message and forward the set of multicast packets via the port.

In a variation on this aspect, the network device can send a multicast query message for the multicast group via the port.

In a further variation, the network device can receive, via the port, a join request for the multicast group as a response to the multicast query message. The network device can also allocate the port as an egress port for the multicast group.

In a variation on this aspect, if the network device does not receive a join request for the multicast group within a predetermined period, the network device can send a withdrawal message for the multicast group to the source network device. Here, the withdrawal message can request the termination of the multicast flow of the multicast group to the first network device.

In a variation on this aspect, the network device can learn a MAC address of the host from the port. The network device can send a third notification message indicating that the MAC address is learned at the first network device.

In a further variation, upon receiving the third notification message, the network device can send a withdrawal message from the second network device to the source network device.

In a variation on this aspect, the network device can determine a MAC address of the host in the first notification message. Here, an indicator in the first notification message indicates the presence of the MAC address in the first notification message. The network device can generate the mapping based on the MAC address of the host.

In a further variation, the first notification message can be an Ethernet virtual private network (EVPN) type 6 message. The indicator can then include an extended community type.

In a variation on this aspect, to forward the set of multicast packets via the port, the network device can decapsulate respective encapsulation headers of the set of multicast packets. The network device can then determine that the set of multicast packets is associated with the multicast group and determine the port as an egress port for the set of multicast packets.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
receiving, by a first network device of an overlay network, a first notification message indicating that a host coupled to a second network device of the overlay network has requested to join a multicast group;
generating, in a data structure in a memory of the first network device, an entry comprising a mapping between the host and the multicast group based on the first notification message;
in response to detecting the host via a port of the first network device, generating a second notification message based on the entry prior to receiving a join request from the host, wherein the second notification message indicates that the host is coupled to the first network device and has requested to join the multicast group;
sending the second notification message to a respective other network device of the overlay network via a corresponding tunnel;
receiving a set of multicast packets of the multicast group via a tunnel coupled to a source network device in response to the source network device receiving the second notification message; and
forwarding the set of multicast packets via the port.

2. The method of claim 1, further comprising sending a multicast query message for the multicast group via the port.

3. The method of claim 2, further comprising:
receiving, via the port, a join request for the multicast group as a response to the multicast query message; and
allocating the port as an egress port for the multicast group.

4. The method of claim 1, wherein, in response to not receiving a join request for the multicast group within a predetermined period, the method further comprises sending a withdrawal message for the multicast group to the source network device, wherein the withdrawal message requests termination of multicast flow of the multicast group to the first network device.

5. The method of claim 1, further comprising:
learning a media access controller (MAC) address of the host from the port; and
sending a third notification message indicating that the MAC address is learned at the first network device.

6. The method of claim 5, wherein, in response to receiving the third notification message, the method further comprises sending a withdrawal message from the second network device to the source network device.

7. The method of claim 1, further comprising:
determining a MAC address of the host in the first notification message, wherein an indicator in the first notification message indicates the presence of the MAC address in the first notification message; and
generating the mapping based on the MAC address of the host.

8. The method of claim 7, wherein the first notification message is an Ethernet virtual private network (EVPN) type 6 message, and wherein the indicator includes an extended community type.

9. The method of claim 1, wherein forwarding the set of multicast packets via the port comprises:
decapsulating respective encapsulation headers of the set of multicast packets;
determining that the set of multicast packets is associated with the multicast group; and
determining the port as an egress port for the set of multicast packets.

10. A non-transitory computer-readable storage medium storing instructions to:
receive, by a first network device of an overlay network, a first notification message indicating that a host coupled to a second network device of the overlay network has requested to join a multicast group;
generate, in a data structure in a memory of the first network device, an entry comprising a mapping between the host and the multicast group based on the first notification message;
in response to detecting the host via a port of the first network device, generate a second notification message based on the entry prior to receiving a join request from the host, wherein the second notification message indicates that the host is coupled to the first network device and has requested to join the multicast group;
send the second notification message to a respective other network device of the overlay network via a corresponding tunnel;
receive a set of multicast packets of the multicast group via a tunnel coupled to a source network device in response to the source network device receiving the second notification message; and
forward the set of multicast packets via the port.

11. The non-transitory computer-readable storage medium of claim 10, wherein the instructions are further to send a multicast query message for the multicast group via the port.

12. The non-transitory computer-readable storage medium of claim 11, wherein the instructions are further to:
receive, via the port, a join request for the multicast group as a response to the multicast query message; and
allocate the port as an egress port for the multicast group.

13. The non-transitory computer-readable storage medium of claim 11, wherein, in response to not receiving a join request for the multicast group within a predetermined period, the instructions are further to send a withdrawal message for the multicast group to the source network device, wherein the withdrawal message requests termination of multicast flow of the multicast group to the first network device.

14. The non-transitory computer-readable storage medium of claim 10, wherein the instructions are further to:
learn a media access controller (MAC) address of the host from the port; and
send a third notification message indicating that the MAC address is learned at the first network device.

15. non-transitory computer-readable storage medium of claim 14, wherein, in response to receiving the third notification message, the instructions are further to send a withdrawal message from the second network device to the source network device.

16. The non-transitory computer-readable storage medium of claim 10, wherein the instructions are further to:
determine a MAC address of the host in the first notification message, wherein an indicator in the first notification message indicates the presence of the MAC address in the first notification message; and
generate the mapping based on the MAC address of the host.

17. The non-transitory computer-readable storage medium of claim 16, wherein the first notification message is an Ethernet virtual private network (EVPN) type 6 message, and wherein the indicator includes an extended community type.

18. The non-transitory computer-readable storage medium of claim 10, wherein, to forward the set of multicast packets via the port, the instructions are further to:
decapsulate respective encapsulation headers of the set of multicast packets;
determine that the set of multicast packets is associated with the multicast group; and
determine the port as an egress port for the set of multicast packets.

19. A computer system, comprising:
at least one processing resource;
a memory; and
a non-transitory computer-readable storage medium storing instructions that when executed by the processing resource cause the computer system to:
receive a first notification message indicating that a host coupled to a second computer system of the overlay network has requested to join a multicast group, wherein the computer system and the second computer system are in an overlay network;
generate, in a data structure in the memory, an entry comprising a mapping between the host and the multicast group based on the first notification message;
in response to detecting the host via a port of the computer system, generate a second notification message based on the entry prior to receiving a join request from the host, wherein the second notification message indicates that the host is coupled to the computer system and has requested to join the multicast group;
send the second notification message to a respective other device of the overlay network via a corresponding tunnel;
receive a set of multicast packets of the multicast group via a tunnel coupled to a source device in response to the source device receiving the second notification message; and
forward the set of multicast packets via the port.

20. The computer system of claim 19, wherein the instructions that when executed by the processing resource cause the computer system to:
send a multicast query message for the multicast group via the port;
in response to receiving a join request for the multicast group within a predetermined period, allocate the port as an egress port for the multicast group; and
in response to not receiving the join request within the predetermined period, send a withdrawal message for the multicast group to the source device, wherein the withdrawal message requests termination of multicast flow of the multicast group to the computer system.
